(19) United States
(12) Patent Application Publication
(10) Pub. No.: US 2006/0089067 A1
(43) Pub. Date: Apr. 27, 2006

(54) Composite fabric with controlled release of functional chemicals

(75) Inventors: John Frank Baker JR., Nashville, TN (US); Peter J. Angelini, Hendersonville, TN (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Reemay, Inc.

(21) Appl. No.: 11/249,109

(22) Filed: Oct. 12, 2005

Related U.S. Application Data
(60) Provisional application No. 60/622,270, filed on Oct. 26, 2004.

(51) Int. Cl. B32B 5/02; B32B 27/04; D04H 13/00; B32B 27/12; D04H 3/16

(52) U.S. Cl. 442/62; 442/60; 442/394; 442/401; 442/337; 442/123

(57) ABSTRACT

The fabric is of a composite construction and includes an air and liquid permeable nonwoven fabric substrate and an air and liquid permeable layer of thermoplastic resin adhered to one surface of the nonwoven fabric substrate and forming one of the exposed surfaces of the composite fabric. A functional chemical is incorporated in the thermoplastic resin layer. Preferably, the liquid permeable layer is a polyolefin film having a plurality of liquid permeable apertures extending therethrough. The functional chemical is blended with the polyolefin resin so that it is present throughout the film layer. The functional chemical diffuses from the film layer to provide for controlled release of the active functional chemical at an optimum duration and rate.

### CROSS-REFERENCE TO RELATED APPLICATIONS

This application is related to and claims priority from U.S. Provisional Patent Application No. 60/622,270 filed Oct. 26, 2004.

### BACKGROUND OF THE INVENTION

The present invention relates to fabrics, and more particularly to nonwoven fabrics, composites and laminates.

Nonwoven fabrics are used in a wide variety of products. For examples, they are an essential part of disposable hygiene products, such as diapers, incontinent garments, and feminine hygiene products. Nonwovens are also used in medical applications, such as surgical gowns, drapes, and medical packaging. Nonwovens also find application in industrial applications such as filtration media, geotextiles such as landscape fabric or underlays for paving, and in protective garments or clothing.

Nonwoven fabrics are most commonly produced from fibers or filaments made from synthetic polymers. Typically, the fibers or filaments are produced by melt spinning a thermoplastic polymer such as polypropylene, nylon, or polyester. In many of the applications where nonwoven fabrics are used, it may be desirable to impart special properties to the nonwoven fabric in addition to the properties inherent in the thermoplastic polymer by incorporating active functional chemicals into the nonwoven fabric. For example, in order to inhibit the growth of microorganisms on the surface of a filter element made from a nonwoven fabric, antimicrobial agents can be incorporated in the nonwoven filtration media. Conventional methods of adding an antimicrobial agent to filtration media include incorporating antimicrobial particles, such as silver chloride, into the fiber structure during melt extrusion of the fibers or subjecting the fibers or the filtration media to a dyeing operation to achieve penetration of the antimicrobial agent into the fiber. Dyeing the fibers is not a viable option for those nonwoven fabric manufacturing processes where fiber formation and nonwoven fabric formation occur in-line, such as the spunbond or meltblown processes. Dyeing the nonwoven fabric after its formation to incorporate the antimicrobial agent is slow and requires additional processing operations that undesirably add to the expense of producing the filtration media.

While some chemicals can be incorporated into the fibers of a nonwoven fabric by melt extrusion during fabric formation, there are numerous active functional chemicals that can not applied in this manner since they are thermally degraded at the extrusion temperatures of the fiber-forming polymers.

Accordingly, there exists a need for a way to incorporate active functional chemicals into a nonwoven fabric that overcomes the aforementioned limitations and problems.

### BRIEF SUMMARY OF THE INVENTION

The present invention provides a nonwoven fabric that overcomes one or more of the aforementioned problems or limitations. The nonwoven fabric is of a composite construction and includes a fluid permeable nonwoven fabric substrate and a fluid permeable layer of a thermoplastic polymer resin, such as a polyolefin, adhered to one surface of the nonwoven fabric substrate. An active functional chemical is incorporated in this resin layer. The active functional chemical is blended with the resin prior to extrusion so that it is present throughout the fluid permeable resin layer. In one preferred embodiment, the fluid permeable resin layer is a polyolefin film having a plurality of apertures extending therethrough which render the film fluid permeable. In another embodiment, the fluid permeable resin layer is formed directly upon the nonwoven fabric substrate by extruding a blend of the resin with the active functional chemical from an extrusion die configured to form an air and water permeable layer on the nonwoven substrate.

The presence of the functional chemical in the permeable polyolefin layer imparts certain characteristics to the composite fabric not provided by the polymer from which the composite fabric is formed. By incorporating the functional chemical into a layer of relatively low melting temperature thermoplastic polymer, the layer is produced at temperatures that will not thermally degrade the active functional chemical. The present invention is especially advantageous for use with nonwoven fabrics formed from fibers or filaments of synthetic polymers that are melt spun at a relatively high extrusion temperature, such as polyester or nylon. By incorporating the active functional chemical in a layer of thermoplastic polymer resin that can be extruded at a significantly lower temperature, such as polyethylene for example, and combining the resin layer with the nonwoven fabric substrate, it is possible to provide the special functional properties of the active functional chemical in the composite fabric.

The fluid permeable nonwoven fabric substrate may be produced by various known nonwoven fabric manufacturing processes. In one advantageous embodiment, the substrate may be a spunbond nonwoven fabric formed from substantially continuous polyester filaments bonded to one another to form a strong coherent fabric. The spunbond nonwoven fabric may have a basis weight of from 12 to 204 grams per square meter. A liquid permeable apertured polyolefin film layer is bonded to one surface of the spunbond nonwoven fabric substrate and forms one of the exposed surfaces of the composite fabric.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic perspective view of a composite fabric in accordance with one embodiment of the present invention;

FIG. 2 is a schematic perspective view of a composite fabric in accordance with another embodiment of the present invention;

FIG. 3 is a scanning electron microscope (SEM) photograph at 50× magnification showing the top surface of a composite fabric in accordance with one embodiment of the present invention; and

FIG. 4 is a SEM at 120× magnification showing the composite fabric of FIG. 3 in cross section.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

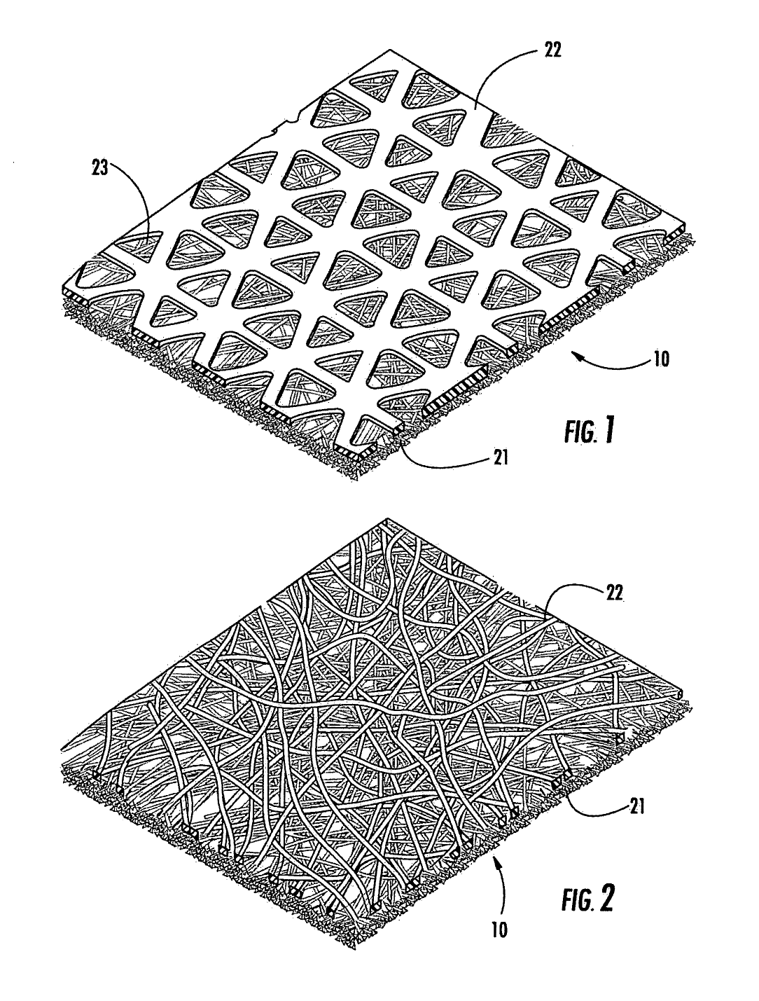

One embodiment of a fabric 10 in accordance with the present invention is shown in greater detail in FIG. 1. The fabric 10 is of a composite construction and includes an air and liquid permeable nonwoven fabric substrate 21 and an air and liquid permeable layer 22 overlying and adhered to one surface of the nonwoven fabric substrate 21 and forming one of the exposed surfaces of the composite 10.

The nonwoven fabric substrate 21 can be produced by any of a number of nonwoven manufacturing processes well known in the industry, including carding, wet laying, air laying, and spunbonding. In the embodiment illustrated, the substrate is a fully bonded air permeable nonwoven fabric formed of continuous filaments. Preferably, the nonwoven fabric is a spunbond nonwoven fabric. Examples of various types of processes for producing spunbond fabrics are described in U.S. Pat. No. 3,338,992 to Kinney, U.S. Pat. No. 3,802,817 to Matsuki, U.S. Pat. No. 4,405,297 to Appel, U.S. Pat. No. 4,812,112 to Balk, and U.S. Pat. No. 5,665,300 to Brignola et al. In general, these spunbond processes include steps of extruding molten polymer filaments from a spinneret; quenching the filaments with a flow of air to hasten the solidification of the molten polymer; attenuating the filaments by advancing them with a draw tension that can be applied by either pneumatically entraining the filaments in an air stream or by wrapping them around mechanical draw rolls of the type commonly used in the textile fibers industry; depositing the attenuated filaments randomly onto a collection surface, typically a moving belt, to form a web; and bonding the web of loose filaments. The continuous filaments are bonded to each other at points of contact to impart strength and integrity to the nonwoven web. The bonding can be accomplished by various known means, such as by the use of binder fibers, resin bonding, thermal area bonding, calendering, point bonding, ultrasonic bonding and the like. The filaments are bonded to each other at points of contact, but the nonwoven structure remains sufficiently open to provide the requisite air and water permeability.

In one advantageous embodiment, the filaments are bonded at a plurality of crossover points throughout the fabric. This type of bonding is commonly referred to as “area bonding”, and is different from “point bonding” where the fibers are bonded to one another at discrete spaced apart bond sites, usually produced by a patterned or engraved roll. In certain preferred embodiments of the present invention, the filaments of the nonwoven fabric substrate are bonded by binder fibers having a lower melting temperature than the primary filaments of the nonwoven fabric. The binder fibers are typically present in amounts ranging independently from about 2 to 20 weight percent, such as an amount of about 10 weight percent. They are preferably formed from a thermoplastic polymer exhibiting a melting or softening temperature at least about 10° C. less than that of the primary continuous filaments. For example, where the primary filaments of the nonwoven fabric substrate 21 are polyester, such as polyethylene terephthalate, the binder fiber is formed from a lower melting polyester copolymer, particularly polyethylene isophthalate copolymer. It should be noted that although binder fibers are incorporated into the nonwoven fabric during manufacture, in many instances, the binder fibers may not be separately identifiable in the nonwoven fabric after bonding because the binder fibers have softened or flowed to form bonds with the continuous filaments of the nonwoven layers. One advantage of using binder fibers for bonding the layers is that there is no added chemical binder present in the nonwoven fabric substrate 21.

Preferably, the spunbond nonwoven fabric is formed of a synthetic fiber-forming polymer which is hydrophobic in nature. Among the well known synthetic fiber-forming polymers, nylon, polypropylene and polyester polymers and copolymers are recognized as being suitable for producing hydrophobic nonwoven webs. Examples of suitable spunbond polyester nonwoven fabrics for use in the present invention include nonwoven fabrics sold by BBA Fiberweb under the trademark REEMAY®, including Style Nos. 2033, 2040, 2295, 2470, as well as point bonded spunbond polyester fabric sold under the trademark DIAMOND WEB, and multi-denier spunbond polyester fabric sold under the trademark REEMAY® X-TREME™.

The spunbond nonwoven fabric substrate 21 may have a basis weight of from 12 to 204 grams per square meter, and more desirably from about 30 to 170 grams per square meter. The continuous filaments of the web preferably have a denier per filament of approximately 1 to 6 and the filaments can have a cross-section ranging from round to trilobal or quadralobal or can include varying cross-sections and varying deniers. For applications such as filtration, the substrate 21 preferably has a thickness of 0.4 to 0.8 mm.

The nonwoven fabric substrate 21 should be permeable to fluids, such as air and water. The permeability of the nonwoven fabric substrate 21 may be conveniently evaluated by measuring its air permeability using a commercially available air permeability instrument, such as the Textest air permeability instrument, in accordance with the air permeability test procedures outlined in ASTM test method D-1117. Preferably, the nonwoven fabric substrate should have an air permeability, as measured by this procedure, of from 150 to 270.

In some applications, it is desirable that the nonwoven fabric be pleatable. For example, when used as a filter medium in a cartridge-type filter, the composite of the present invention should have a thickness, basis weight and stiffness that allows for pleating using commercially available pleating processes and machinery, such as rotary and push-bar type pleaters. In these applications, the substrate 21 should be capable of being formed into sharp creases or folds without loss of strength. If additional stiffness is desired for the nonwoven fabric substrate beyond that obtained from the initial nonwoven manufacturing operation, a stiffening coating (not shown) may be applied to one or both surfaces of the nonwoven fabric substrate. More particularly, at least one of the exposed surfaces may be provided with a resin coating for imparting additional stiffness to the nonwoven fabric so that the fabric may be pleated by conventional pleating equipment. By varying the amount of resin coating applied, the air permeability of the nonwoven fabric substrate may also be controlled as required for specific filtration applications. The resin coating may be applied to the nonwoven fabric using conventional coating techniques such as spraying, knife coating, reverse roll coating, or the like. Exemplary resins include acrylic resin, polyesters, nylons or the like. The resin may be supplied in the form of an aqueous or solvent-based high viscosity liquid or paste, applied to the nonwoven fabric, e.g. by knife coating, and then dried by heating.

The air and liquid permeable layer 22 is formed of a thermoplastic resin having a relatively low melting temperature as compared to the polymer from which the nonwoven fabric substrate 21 is formed. Polyolefins have a suitably low extrusion temperature, and polyethylene or polyethylene polymers and copolymers are particularly suitable. The liquid permeability of the layer 22 is attributable to the presence of a multiplicity of interstices or apertures in the layer. Preferably the liquid permeable layer 22 should have an air permeability prior to combining with the nonwoven substrate 21 of at least 150 cfm/ft²/min, and desirably at least 800 cfm/ft²/min., as measured using a Textest air permeability instrument in accordance with test standard ASTM D-1117. The interstices or apertures are present throughout the surface of the layer and form a significant proportion of its surface area. Preferably, the apertures constitute at least 25% of the surface area of the layer, and more desirably, 35% or greater.

In the embodiment illustrated in FIG. 1, the air and liquid permeable layer 22 is an apertured film. The apertured film layer 22 may be produced as a separate free-standing film which is subsequently rendered air and water permeable by a suitable perforating or aperturing process, and the apertured film is subsequently laminated to one surface of the nonwoven fabric substrate. For example, the film layer 22 may be produced by extruding the molten polyolefin resin from a film die, cooling the film, embossing the film and then orienting the film in the machine and/or cross-machine direction so that areas of the film rupture to produce a uniform pattern of apertures 23 of similar size and shape throughout the film. A process and resulting film of this type is described, for example, in U.S. Pat. Nos. 5,207,923 and 5,262,107, the contents of which are incorporated herein by reference. Suitable apertured film of this type is commercially available from DelStar Technologies, Inc. under the registered trademark DELNET®. Other apertured films for use in the present invention may be produced using apertured film processes controlled by Tredegar, Inc. of Richmond, Va. The functional chemical-containing apertured film 22 is bonded to one surface of the liquid permeable nonwoven fabric substrate 21. The bonding can be carried out using an additional adhesive agent or the film can be laminated directly to the nonwoven fabric substrate by ultrasonic bonding or by heat and pressure. For example, the film layer 22 may be laminated directly to one surface of the nonwoven fabric substrate 21 by passing the two layers through a nip formed by a cooperating pair of heated, smooth-surfaced calender rolls.

In one preferred embodiment, the polyolefin film layer 22 is formed from a polyethylene resin, and most desirably from high density polyethylene. Alternatively, the film layer 22 may comprise more than one polymer composition, such as a coextrusion of a polyethylene resin with one or more adhesive-forming copolymer outer layers (e.g. EAA copolymer) that will facilitate thermal lamination of the film layer 22 to the nonwoven fabric substrate 21.

In another embodiment, the layer 22 may be formed directly upon the nonwoven fabric substrate 21. For example, molten polyolefin polymer may be extruded directly onto the nonwoven fabric substrate 21 from an extrusion die configured to form a discontinuous air and water permeable layer 22 on the nonwoven fabric substrate. The extrusion die may, for example, be configured to form an extruded net or scrim having a multiplicity of apertures to give the layer 22 the requisite permeability. Alternatively, the molten polymer may be extruded in the form of strands, such as fibers or continuous filaments, directly onto the surface of the nonwoven fabric substrate 21, or it may be sprayed onto the surface of the substrate 21 from a melt-blowing die or similar apparatus in the form of fibers or filaments that have interstices therebetween providing the requisite air and water permeability. In the embodiment illustrated in FIG. 2, the layer 22 is an air and water permeable web of polyethylene fibers melt-extruded from a die and sprayed directly onto the nonwoven fabric substrate 21. The layer 22 is open and porous, containing numerous interstices between the fibers, to provide a high permeability to air and water.

Prior to extrusion, the resin used to form the layer 22 may be blended with additives of the type conventionally used in extrusion such as slip agents, stabilizers, antioxidants, pigments and the like. In addition, in accordance with the present invention, at least one active functional chemical is blended with the resin. Preferably, the functional chemical is present in the film layer 22 at a concentration of from 0.01%% to 10% by weight, based on the weight of the film layer, and for some applications, preferably up to about 5% by weight. The specific concentration employed is dictated by the type of active functional chemical used and the intended effect and can be readily determined without undue experimentation using routine screening tests.

The term “active functional chemical” as used herein refers to a chemical compound having active chemical properties that achieve an intended function in the composite material. The compound is typically a liquid or a solid. It is mixed with the polyolefin resin prior to extrusion of the layer 22 by various known techniques, such as by blending with the raw material resin granules prior to extrusion, by injection into the extruder barrel, or by compounding the active functional chemical with other materials to form a masterbatch composition that is then either mixed with the resin granules by blending or introduced directly to the extruder barrel. The active functional chemical becomes intimately mixed with the molten polyolefin resin. In principle, there is no restriction on the nature or composition of the active functional chemicals used in the polyolefin resin layer, so long as the active functional chemical has sufficient thermal stability to withstand the extrusion temperature of the polyolefin resin. Examples of active functional chemicals that can be used in the present invention include insecticides, herbicides, pesticides, fungicides, antimicrobial agents, antiviral compounds, antibacterial agents, disinfectants, plant growth stimulators, plant protection agents, pheromones, chemical attractants for animals or insects, chemical repellants for animals or insects, oxygen scavenger compounds, scents, enzymes, pharmaceutically active compounds, vitamins, nutrients, dyes and fertilizers.

Examples of herbicides include dinitroaniline compounds such as trifluralin, profluralin, pendimethalin, oryzalin, ethalfluralin, isopropalin and benefin. These compounds have a thermal decomposition temperature well below the extrusion temperature of polyethylene. Examples of antimicrobial compounds include triclosan, aromatic nitrites (such as tetrachloroisophthalonitrile); 3,5,3′,4′-tetrachlorosalicylanilide (also known as Irgasan, a product of Ciba-Geigy Company); chlorinated phenols such as 5-chloro-2-(2,4-dichloro-phenoxy)phenol and 2,4,4′-trichloro-2′hydroxy diphenol ether (commonly sold under the trademark Microban®) by Microban Products Company). Examples of odor inhibiting chemicals include amine-type antioxidants and hindered phenols.

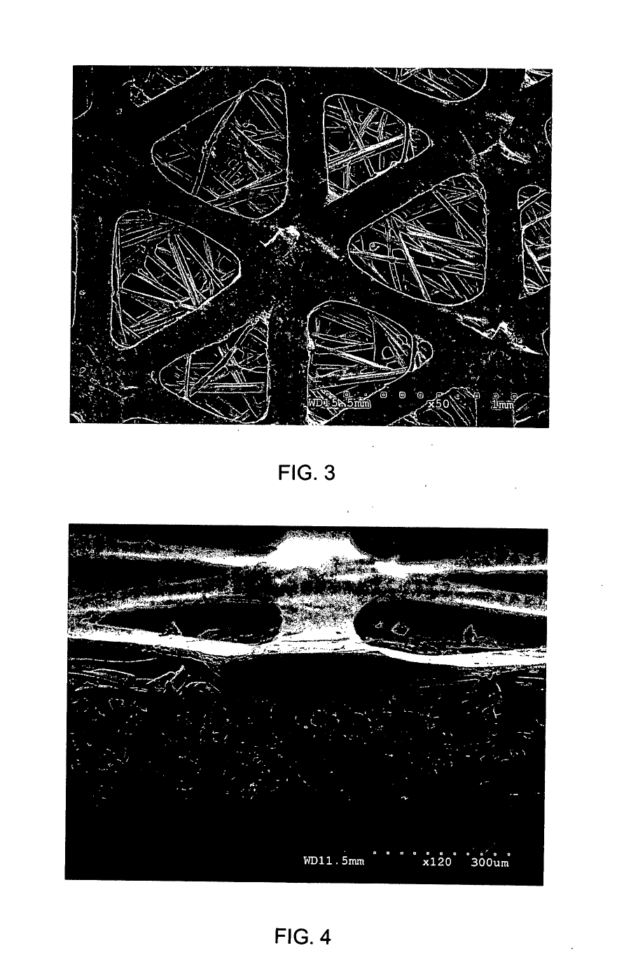

The scanning electron microscope photograph of FIG. 3 illustrates a composite in accordance with the present invention formed by combining a spunbond nonwoven fabric substrate layer with an apertured high density polyethylene film layer. The apertures of the film layer 22 are considerably larger than the interstices defined by the intersecting filaments of the underlying nonwoven fabric substrate 21. Because of the relatively large size of the apertures, the presence of the film layer 22 does not impair the fluid flow properties of the nonwoven fabric substrate 21. FIG. 3 clearly reveals the trilobal cross-sectional configuration of the filaments of the nonwoven fabric substrate 21. It can also be seen that the nonwoven fabric substrate 21 has a thickness significantly greater that that of the apertured film layer 22, and that the film layer is firmly bonded to the nonwoven fabric substrate. The film layer is bonded to the nonwoven layer by fusion bonds resulting from the softening of the film layer, and in addition, there is a mechanical bond resulting from the filaments at the surface of the nonwoven fabric substrate becoming embedded in the film layer.

The composite nonwoven fabric of the present invention can be used in a variety of applications where the properties imparted by the functional chemical can be effectively utilized. For example, a landscape fabric in accordance with the present invention can incorporate a herbicide or root growth retardant, such as trifluralin, in the layer 22 to prevent the germination of seeds where the landscape fabric is used in natural areas beneath a mulch layer. A landscape fabric incorporating a growth stimulator compound can be used as a crop cover. Fabrics incorporating insect repellents can be fabricated into garments to be worn outdoors in insect infested areas. Garments can be produced from nonwoven fabrics incorporating functional chemicals that mask odors. Protective sheets for packaging can be produced incorporating oxygen scavenger compounds that will prevent or retard corrosion or oxidation.

The size of the apertures or interstices in the permeable polyolefin layer 22 and its porosity may be varied depending upon the intended end use. By reducing the porosity and/or aperture size, the layer 22 can provide the composite fabric 10 with a degree of water repellency, where, for example, the composite fabric is to be used as a garment or in wet environments. The layer 22 can also serve to impart release properties to the composite. By forming a relatively slick surface on the composite, the layer 22 will facilitate the release of dirt or the like from the surface of the composite fabric by rinsing. This is especially advantageous when the composite fabric 10 is used in filtration applications.

The air and water permeable polyolefin layer 22 also provides for controlled release of the active functional chemical so that the active functional chemical is delivered at an optimum time and rate. The diffusion rate of the active functional chemical through the polyolefin layer can be controlled by appropriate selection of the chemical properties of the polyolefin, such as its chemical composition, molecular weight, density, or crystallinity, as well as by blending of the olefin resin with other polymers, copolymers or modifiers. For example, selection of a high density polyethylene over a low density polyethylene would retard the release of the active chemical. The release of the active functional chemical can also be controlled through the selection of the particular active functional chemical, its chemical properties (e.g. pH, molecular weight, crystallinity, etc.), its size, the use of complexing agents with the active functional chemical, and in other ways.

The following non-limiting examples are provided to illustrate various embodiements of the invention.

### EXAMPLE 1

A roll of spunbond polyester nonwoven fabric filtration medium produced by BBA Nonwovens as Reemay® grade 2033 having the properties shown in Table 1 below was placed on an unwind stand. The nonwoven fabric filtration medium is formed from polyethylene terephthalate filaments of a generally trilobal cross-section having a linear density of 4 denier per filament. The fabric is area bonded by a polyethylene isophthalate copolymer binder. A roll of apertured high density polyethylene film produced by DelStar Technologies, Inc. and having the properties shown in Table 1 was mounted on a second unwind stand. As the nonwoven fabric was unrolled from the roll, the film was unrolled and directed onto one surface of the nonwoven fabric filtration. These two layers were directed through a nip formed by heated smooth-surfaced calender rolls to laminate the film layer to the nonwoven fabric layer, producing a composite filtration medium having the basis weight, thickness and air permeability described in Table 1.

TABLE 1

| | Nonwoven fabric | Film | Combined |
|---|---|---|---|
| Unit Weight, gsm | 100 | 18 | 118 |
| Thickness, mm | 0.43 | 0.14 | 0.39 |
| Air Perm, cfm | 256 | 800 | 164 |
| Other | 100% | Anti-microbial | Heat laminated |
| | 4 dpf trilobal fibers | content | construction |
| | | 1,500 PPM | |
| | | Microban ® B | |

### EXAMPLE 2

Samples of the composite filtration medium of Example 1 were subjected to testing for compliance with the National Sanitation Foundation (NSF) requirements for pool and spa filters. The samples were tested in accordance with FDA standard 21 C.F.R. §177.1630 for polyester fabrics and 21 C.F.R. §177.1520 for polyolefin fabrics for extractives. The extractives were well under the limits specified in these regulations, as seen in the following table.

| Test | Standard | Sample | Sample | Sample |
|---|---|---|---|---|
| 21 CFR | Max. | Chloroform | Chloroform | Chloroform |
| 177.1630 | chloroform- | soluble | soluble | soluble |
| | soluble | extractives | extractives | extractives |
| | extractives | from water | from heptane | from 50% ethanol |
| | 0.2 | 0.0000 | 0.0144 | 0.0308 |
| 21 CFR | Max. | Extractable | | |
| 177.1520 | extractable | fraction in | | |
| | fraction in | n-hexane | | |
| | n-hexane | | | |
| | 6.4 | 0.0556 | | |
| | Max. | Extractable | | |
| | extractable | fraction in | | |
| | fraction in | xylene | | |
| | xylene | | | |
| | 9.8 | 1.31 | | |

### EXAMPLE 3

The turbidity reduction and the plug time characteristics of the composite filtration medium of Example 1 were compared to a control sample formed of the Reemay 2033 spunbond nonwoven fabric alone. Turbidity reduction was measured in accordance with the NSF/ANSI Standard 50. Plug time was evaluated by monitoring the pressure drop across the filter versus time. Comparative results show that the composite medium of the invention exhibits turbidity reduction comparable to that of the control, and that the additional presence of the apertured film layer did not alter the pressure drop across the filter during normal operation and did not significantly reduce the plug time. After the plug time test, the two samples were rinsed to remove the accumulated filter cake. The filter cake was readily removed from the composite filtration medium of the invention by rinsing under running water. In the control sample, some of the filter cake was rinsed off, but some remained adhered to the control sample.

### EXAMPLE 4

A composite filtration medium is produced by a procedure similar to that described in Example 1, except that a blue dye is additionally incorporated into the apertured polyethylene film layer. When used as a liquid filter, the blue dye diffuses out of the film over several months use. Thus, when the film layer turns from a blue color to colorless, this serves as a visual indicator of when the filter should be replaced.

### EXAMPLE 4

A composite fabric is produced by a procedure similar to that described in Example 1, except that instead of incorporating an antimicrobial agent into the film layer, a trifluralin, a herbicide and root-growth retardant is blended into the polyethylene apertured film. The composite is useful as a landscape fabric and as a fabric for wrapping around pipes buried in the ground to prevent intrusion of roots into the pipes.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A composite fabric comprising an air and liquid permeable nonwoven fabric substrate, an air and liquid permeable layer of polyolefin resin adhered to one surface of the nonwoven fabric substrate and forming one of the exposed surfaces of the composite fabric, and at least one active functional chemical incorporated in the layer of polyolefin resin.

2. The composite fabric of claim 1, wherein the air and liquid permeable layer of polyolefin resin comprises an extruded film of polyolefin resin having a plurality of apertures rendering the film permeable to air and liquid.

3. The composite fabric of claim 2, wherein the film layer has a basis weight of from 10 to 50 grams per square meter.

4. The composite fabric of claim 1, wherein the air and liquid permeable layer of polyolefin resin comprises strands of extruded polyolefin resin bonded to one surface of the nonwoven fabric substrate and forming an air and water permeable layer.

5. The composite fabric of claim 1, wherein the liquid permeable nonwoven fabric substrate forms the opposite surface of the composite fabric.

6. The composite fabric of claim 1, wherein the liquid permeable nonwoven fabric substrate comprises a spunbond nonwoven fabric formed from substantially continuous thermoplastic polymer filaments bonded to one another to form a strong coherent fabric.

7. The composite fabric of claim 6, wherein the spunbond nonwoven fabric has a basis weight of 12 to 204 grams per square meter.

8. The composite fabric of claim 1, wherein the liquid permeable nonwoven fabric substrate has a thickness of 0.4 to 0.9 mm and an air permeability of from 150 to 270 cfm/ft²/min.

9. The composite fabric of claim 1 which has an air permeability of at least 150 cfm/ft²/min.

10. The composite fabric of claim 1 wherein the active functional chemical is selected from the group consisting of insecticides, herbicides, pesticides, fungicides, antimicrobial agents, antiviral compounds, antibacterial agents, disinfectants, plant growth stimulators, plant protection agents, pheromones, chemical attractants for animals or insects, chemical repellants for animals or insects, oxygen scavenger compounds, scents, enzymes, pharmaceutically active compounds, vitamins, nutrients, dyes and fertilizers.

11. A composite fabric comprising an air and liquid permeable spunbond nonwoven fabric substrate formed of continuous filaments, an air and liquid permeable apertured film layer of polyethylene resin bonded to one surface of the nonwoven fabric substrate and forming one of the exposed surfaces of the composite fabric, and at least one functional chemical incorporated in the film layer.

12. The composite fabric of claim 11, wherein the substantially continuous filaments of the nonwoven fabric substrate include polyester filaments of a trilobal cross-section.

13. A composite fabric comprising an air and liquid permeable spunbond nonwoven fabric substrate having a basis weight of from 12 to 204 grams per square meter, a thickness of from 0.4 to 0.9 millimeters, and formed of continuous filaments bonded to one another, an air and liquid permeable polyethylene layer bonded to one surface of the nonwoven fabric substrate and forming one of the exposed surfaces of the composite fabric, the polyethylene layer having an air permeability of at least 150 cfm/ft²/min, and at least one functional chemical incorporated in the polyethylene layer.

14. The composite fabric of claim 13, wherein the substantially continuous filaments of the nonwoven fabric substrate include polyester filaments of a trilobal cross-section.

15. The composite fabric of claim 14, wherein the polyethylene layer has a basis weight of 10 to 50 gsm.

16. The composite fabric of claim 13, wherein the at least one functional chemical is present in the polyethylene layer at a concentration of from 0.01% to 10% by weight, based on the weight of the polyethylene layer.

17. The composite fabric of claim 13, wherein the active functional chemical is selected from the group consisting of insecticides, herbicides, pesticides, fungicides, antimicrobial agents, antiviral compounds, antibacterial agents, disinfectants, plant growth stimulators, plant protection agents, pheromones, chemical attractants for animals or insects, chemical repellants for animals or insects, oxygen scavenger compounds, scents, enzymes, pharmaceutically active compounds, vitamins, nutrients, dyes and fertilizers.
